(19) United States
(12) Patent Application Publication
(10) Pub. No.: US 2006/0291107 A1
(43) Pub. Date: Dec. 28, 2006

(54) Magnetoresistive element with tilted in-stack bias

(75) Inventors: Rachid Sbiaa, Tokyo (JP); Isamu Sato, Tokyo (JP); Haruyuki Morita, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: TDK CORPORATION; KABUSHIKI KAISHA TOSHIBA

(21) Appl. No.: 11/157,952

(22) Filed: Jun. 22, 2005

(51) Int. Cl. G11B 5/127; G11B 5/33

(52) U.S. Cl. 360/324.12

(57) ABSTRACT

An in-stack bias is provided for stabilizing the free layer of a magneto-resistive sensor. More specifically, a stabilizer layer provided above a free layer has a tilted magnetization. As a result of this tilt, the interlayer coupling between the free layer and the pinned layer is reduced, and the related art hysteresis and asymmetry problems are substantially overcome. Additionally, a method of tilting the stabilizer layer of the in-stack bias is also provided, including a method of annealing using annealing temperature differentials and magnetic field directions.

### BACKGROUND OF THE INVENTION

1. Technical Field

The present invention relates to a magnetoresistive element having an in-stack bias, and more specifically, to a magnetoresistive sensor having a tilted in-stack bias.

2. Related Art

In the related art magnetic recording technology such as hard disk drives, a head is equipped with a reader and a writer that operate independently of one another. The reader includes a free layer, a pinned layer, and a spacer between the pinned layer and the free layer.

In the reader, the direction of magnetization in the pinned layer is fixed. However, the direction of magnetization in the free layer can be changed, for example (but not by way of limitation) depending on the effect of an external field, such as the recording medium.

When the external field (flux) is applied to a reader, the magnetization of the free layer is altered, or rotated, by an angle. When the flux is positive, the magnetization of the free layer is rotated upward; when the flux is negative, the magnetization of the free layer is rotated downward. If the applied external field changes the free layer magnetization direction to be aligned in the same way as pinned layer, then the resistance between the layers is low, and electrons can more easily migrate between those layers However, when the free layer has a magnetization direction opposite to that of the pinned layer, the resistance between the layers is high. This high resistance occurs because it is more difficult for electrons to migrate between the layers.

FIG. 1(a) illustrates a related art tunneling magnetoresistive (TMR) spin valve for the CPP scheme. In the TMR spin valve, the spacer 23 is an insulator, or tunnel barrier layer. Thus, the electrons can cross the insulating spacer 23 from free layer 21 to pinned layer 25 or verse versa. TMR spin valves have an increased magnetoresistance (MR) on the order of about 50%.

FIG. 1(b) illustrates a related art current perpendicular to plane, giant magnetoresistive (CPP-GMR) spin valve. In this case, the spacer 23 acts as a conductor. In the related art CPP-GMR spin valve, there is a need for a large resistance change ΔR, and a moderate element resistance for having a high frequency response. A low coercivity is also required so that a small media field can be detected. The pinning field should also have a high strength.

FIG. 1(c) illustrates the related art ballistic magnetoresistance (BMR) spin valve. In the spacer 23, which operates as an insulator, a ferromagnetic region 47 connects the pinned layer 25 to the free layer 21. The area of contact is on the order of a few nanometers. As a result, there is a substantially high MR, due to electrons scattering at the domain wall created within this nanocontact. Other factors include the spin polarization of the ferromagnets, and the structure of the domain that is in nano-contact with the BMR spin valve.

In the foregoing related art spin valves, the spacer 23 of the spin valve is an insulator for TMR, a conductor for GMR, and an insulator having a magnetic nano-sized connector for BMR. While related art TMR spacers are generally made of more insulating metals such as alumina, related art GMR spacers are generally made of more conductive metals, such as copper.

In the related art, it is necessary to avoid high interlayer coupling between the pinned layer and the free layer, so that magnetization of the free layer is only affected by the media field itself during the read operation. High interlayer coupling has the undesired effect of negatively affecting the output read signal. For example, the signal asymmetry and the hysteresis are substantially increased. This effect is disclosed in Cespedes et al. (Journal of Magnetism and Magnetic Materials, 272-76: 1571-72 Part 2, 2004).

In the current confined path-CPP head, the spacer is made of non-magnetic, conductive areas that are separated from one another by an insulator, such as Cu—Al₂O₃. Accordingly, interaction between the free layer and the pinned layer is increased as the thickness of the layers decreases, especially in the cases of GMR and TMR. For example, in the TMR head, the insulating spacer is made very thin to reduce overall device resistance. This reduced TMR spacer thickness also causes the creation of pinholes between the free layer and the pinned layer, which results in an increased interlayer coupling.

In the case of BMR, the interlayer coupling increases as a function of the nanocontacts (which are direct connections) present in the spacer between the free layer and the pinned layer. When the free layer and the pinned layer have opposite magnetization directions, a magnetic domain wall can be created. As a result, a high MR ratio can be obtained, with strong electron scattering. For example, when the free layer and the pinned layer are connected by Ni magnetic nanoparticles embedded in an alumina matrix of the spacer, a high interlayer coupling that is greater than about 100 Oersteds (possibly about 200 Oersteds) occurs. As a result, the transfer curve (i.e., voltage as a function of the external magnetic field) becomes asymmetric, and the output signal is substantially reduced.

To address the foregoing related art problems, a related art stabilizer layer is used to make the free layer mono-domain. This stabilizer layer is illustrated in FIG. 2. A spacer 51 is positioned between the pinned layer 53 and the free layer 55, and a non-magnetic spacer layer 57 is positioned on a side of the free layer 55 opposite the spacer 5 1. Above the non-magnetic spacer layer 57, a stabilizer layer 59 is provided. As a result of the stabilizer layer 59, the free layer 55 becomes mono-domain, as the difference in magnetization direction between the stabilizer layer and the spacer is about 180 degrees.

In a related art simulation, the desired stabilizing field was determined for the case of no interlayer coupling, and for the case of interlayer coupling. Without interlayer coupling, the hysteresis of the free layer disappears at an external field strength of about 150 Oersteds for NiFe as free layer having the size of 100 nm by 100 nm. A field strength that is too strong will result in a reduced stiffness or sensitivity of the free layer, whereas a field strength that is too weak will result in a reduced stability. A transfer curve with a hysteresis will also be a problem. However, as the free layer width is decreased, the demagnetizing field increases, leading to even larger hysteresis. By adding the interlayer coupling of 100 Oersteds and a bias field of 150 Oe, the hysteresis problem is substantially reduced, with the bias field acting in the free layer easy axis, but the bias point is shifted from the origin.

However, there is still another problem in the related art, even if the related art hysteresis problem is addressed. For example, there is still a related art problem of the asymmetry that is due to the interlayer coupling. Thus, there is an unmet need in the related art, as illustrated in FIGS. 1 and 2, to overcome the related art asymmetry problem.

### SUMMARY OF THE INVENTION

It is an object of the present invention to overcome the related art problems and disadvantages. However, such an object, or any object, need not be achieved in the present invention.

A magnetoresistive element is provided that has a free layer having a magnetization adjustable in response to an external magnetic field, a pinned layer having a substantially fixed magnetization, and a spacer sandwiched between the pinned layer and the free layer. Further, a continuous, non-disjoined stabilizer layer is provided and is positioned on the free layer and opposite the spacer. The stabilizer layer has a magnetization direction that is tilted, and the magnetoresistive element does not include a side hard bias layer.

Additionally, a magnetoresistive element is provided that includes a free layer having a magnetization direction adjustable in response to an external magnetic field, a pinned layer having a substantially fixed magnetization direction, a spacer sandwiched between the pinned layer and the free layer, and a continuous, non-disjoined stabilizer layer positioned on the free layer opposite the spacer. The stabilizer layer has a magnetization direction that is tilted. Also provided is an insulator positioned on side surfaces of the stabilizer layer, the spacer, the pinned layer and the free layer, and a side hard bias positioned at an outer surface of the insulator. The spacer comprises an insulator matrix having at least one conductive nano-contact between the free layer and the pinned layer, and the at least one conductive nano-contact is one of magnetic and non-magnetic.

Also, a magnetoresistive element is provided that includes a free layer having a magnetization direction adjustable in response to an external magnetic field, a pinned layer having a substantially fixed magnetization direction, a spacer sandwiched between the pinned layer and the free layer, and a continuous, non-disjoined stabilizer layer positioned on the free layer opposite the spacer. The stabilizer layer has a magnetization direction that is tilted. Additionally, an insulator is positioned on side surfaces of the stabilizer layer, the spacer, the pinned layer and the free layer, and a side hard bias positioned at an outer surface of the insulator. The spacer comprises an insulator.

Further, a device is provided that includes a free layer having a magnetization adjustable in response to an external magnetic field, a pinned layer having a substantially fixed magnetization, a spacer sandwiched between the pinned layer and the free layer, and a continuous, non-disjoined stabilizer layer positioned on the free layer and opposite the spacer. The stabilizer layer has a magnetization direction that is tilted, and the magnetoresistive element does not include a side hard bias layer.

### BRIEF DESCRIPTION OF THE DRAWINGS

FIGS. 1(a)-(c) illustrates various related art magnetic reader spin valve systems;

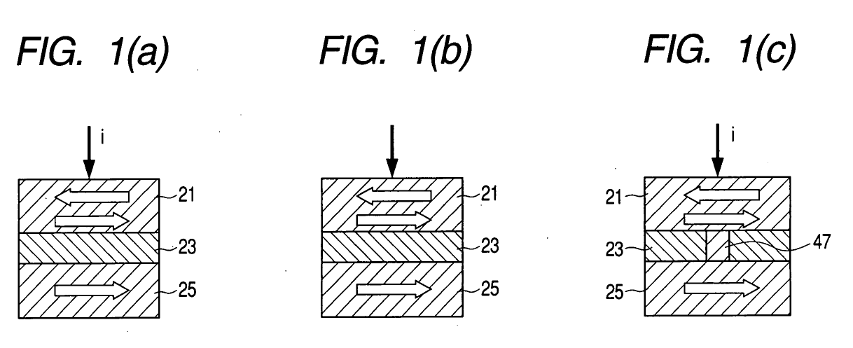

FIG. 2 illustrates the related art spin valve having a stabilizer layer;

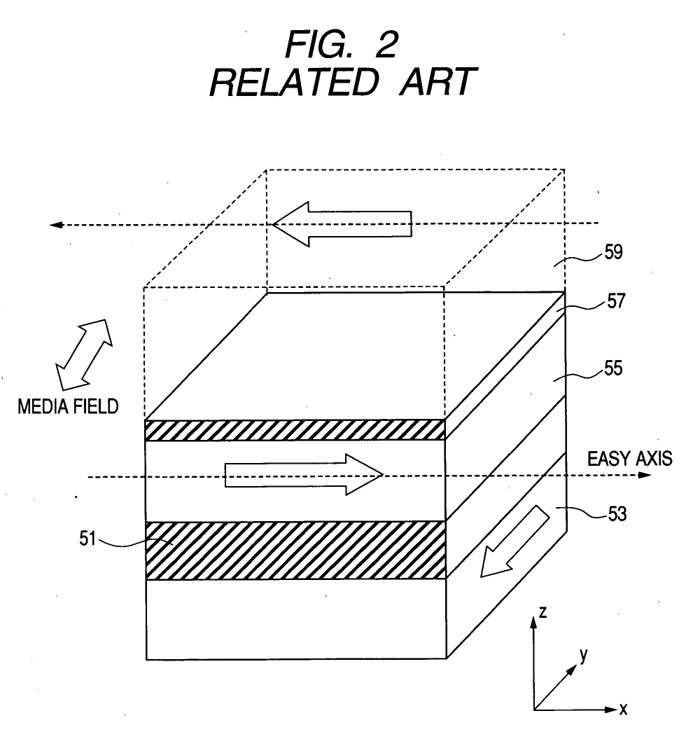

FIG. 3 illustrates a spin valve according to an exemplary, non-limiting embodiment of the present invention;

FIG. 4 illustrates a bottom spin valve according to an exemplary, non-limiting embodiment of the present invention;

FIG. 5 illustrates an angle of tilting according to an exemplary, non-limiting embodiment of the present invention; and

FIG. 6 illustrates a device that includes a side shield according to an exemplary, non-limiting embodiment of the present invention.

### DETAILED DESCRIPTION OF THE EMBODIMENTS

The exemplary, non-limiting embodiments include a magnetoresistive element with tilted in-stack bias according to the exemplary, non-limiting embodiments described herein, and equivalents thereof as would be known by one of ordinary skill in the art. Further, in the embodiments, where the composition of the layers is not provided, those layers have the composition as would be known by one of ordinary skill in the art.

In the present embodiments, a tilted stabilizer layer is provided that is a continuous, single and completely joined (i.e., non-disjoined) layer. This stabilizer layer acts to induce two components of the magneto static field. The first component is in the direction of the free layer easy axis, and acts to stabilize the free layer in a mono-domain structure.

The second component is in a direction about 90 degrees from the direction of the first component, and acts to reduce (compensate) the interlayer coupling between the pinned layer and the free layer by application of a magnetic field in the opposite direction of the interlayer coupling. Accordingly, the related art asymmetry and hysteresis problems are substantially overcome.

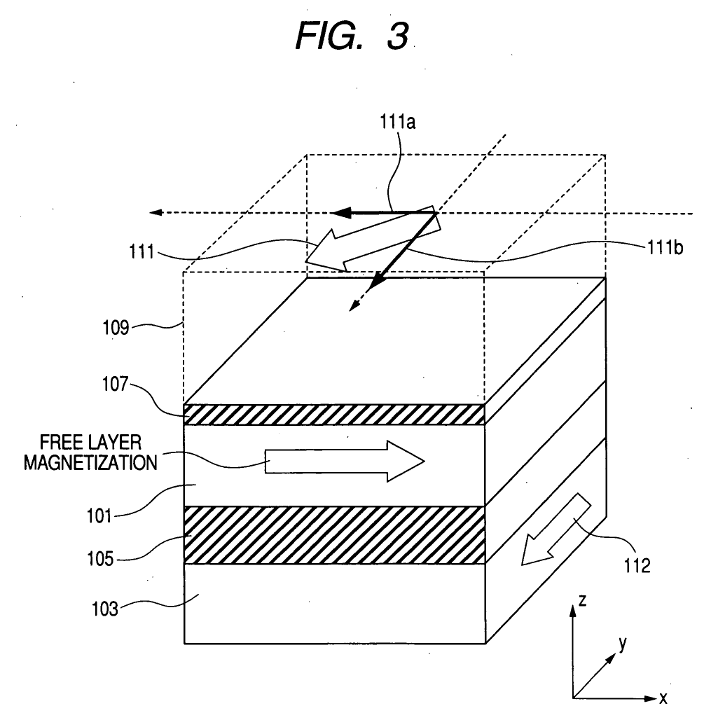

FIG. 3 illustrates a spin valve according to an exemplary, non-limiting embodiment. The spin valve includes a free layer 101 that is separated from a pinned layer 103 by a spacer 105 sandwiched therebetween. Additionally, a non-magnetic spacer layer 107 is provided above the free layer 101. The free layer 101 has a magnetization adjustable in response to an external magnetic field, and the pinned layer 103 has a substantially fixed magnetization.

Above the non-magnetic spacer layer 107, a stabilizer layer 109 is provided. The stabilizer layer 109 of the present invention has various specific properties. For example, but not by way of limitation, this stabilizer layer is a single, continuous ferromagnetic layer in the horizontal direction. Further, the stabilizer layer 109 is completely joined, without any gaps therein. The stabilizer layer 109 covers substantially the entire free layer 101 as a substantially continuous, non-disjoined layer.

Additionally, the stabilizer layer 109 has its magnetization direction 111 tilted from a direction about 180 degrees with respect to the free layer magnetization direction. The free layer magnetization direction is about 90 degree from the pinned layer magnetization direction. As noted above, a first component 111a is directed to maintaining free layer stability, and a second component 111b, which is about 90 degrees with respect to the first component, and has the same direction as the pinned layer magnetization direction, is directed to compensating interlayer coupling between the free layer 101 and the pinned layer 103. In this embodiment, the magnetoresistive element does not include a side hard bias layer.

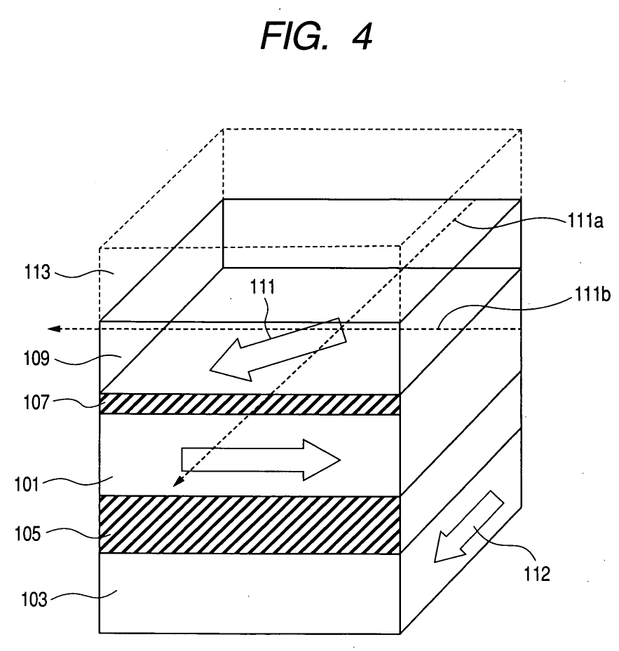

FIG. 4 illustrates a bottom spin valve according to an exemplary, non-limiting embodiment. Further description of the remaining reference characters that have substantially the same description as provided above with respect to FIG. 3 is omitted for the sake of clarity. Additionally, an AFM layer can be 113 as described above is positioned above the stabilizer layer 109. Alternatively, a hard magnet layer can be used instead of the AFM for achieving a substantially similar function.

FIG. 4 illustrates a bottom spin valve according to an exemplary, non-limiting embodiment. However, a top spin valve can be used, as would be known by one of ordinary skill in the art. Further, a buffer layer (not illustrated) can be provided below the AFM layer and top or bottom shield can be used.

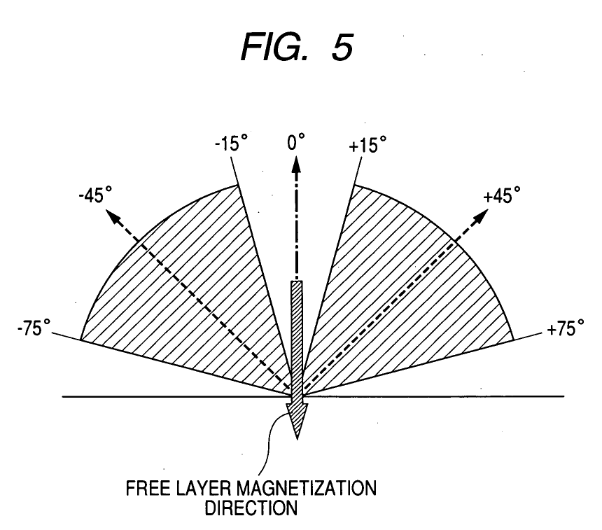

Further details of the degree of tilting and the angle of the tilt will now be discussed, and are illustrated in FIG. 5. In the related art, there is no tilt from a direction that is about 180 degrees with respect to the free layer magnetization direction. Thus, the related art tilt angle is considered to be about 0 degrees. This may also be referred to as the “origin” position.

However, in the present invention, the “tilt” is defined to include an angle that is However, in the present invention, the “tilt” is defined to include an angle that is within a range of plus or minus about 30 degrees (e.g., about 15 to about 75 degrees) around the positions of about ±45 degrees as shown in FIG. 5. Thus, “tilted” is defined by two regions in either direction from the origin (dashed area in FIG. 5).

The tilt of about 45 degrees away from the origin is approximate, and is only limited by the strength of the coupling. Whether the tilt extends at a +]or − degree depends on the coupling between the free layer and the pinned layer. For example, but not by way of limitation, if the coupling strength is moderate, then the tilt angle will be smaller, and if the coupling strength is higher, then the tilt angle must be larger to compensate for this higher coupling strength.

The stabilizer layer 109 can be made substantially larger than the free layer 101. Further, for the spacer 105, this layer can be an insulator comprising Al₂O₃, MgO, or a similar material as would be known by one of ordinary skill in the art. Accordingly, such a structure can be used in a TMR head, which is discussed above with respect to the related art.

Alternatively, the spacer 105 can be a conductive layer such as, for example but not by way of limitation, Cu, or a similar material as would be known by one of ordinary skill in the art. Accordingly, such a structure can be used in a GMR head, which is discussed above with respect to the related art.

In other alternative and exemplary, non-limiting embodiments, the spacer 105 can include an insulator matrix having a conductive material therein that electrically couples the free layer 101 to the pinned layer 105. The conductive material may be non-magnetic (e.g., Cu), or it may be magnetic (e.g., at least one of Ni, Co, and Fe). The conductive material constitutes a nano-contact between the free layer and the pinned layer.

When the conductive material is non-magnetic, the device is considered to be a current-confined path with a current perpendicular to plane (CCP-CPP) head. Alternatively, when the material is magnetic, the device is considered to be a BMR device, as discussed above with respect to the related art.

However, the foregoing TMR, GMR, CCP-CPP and BMR heads according to the present invention will differ from the related art heads in terms of the tilting of the stabilizer layer 109, which reduces the related art hysteresis and asymmetry problems by addressing the related art interlayer coupling issues.

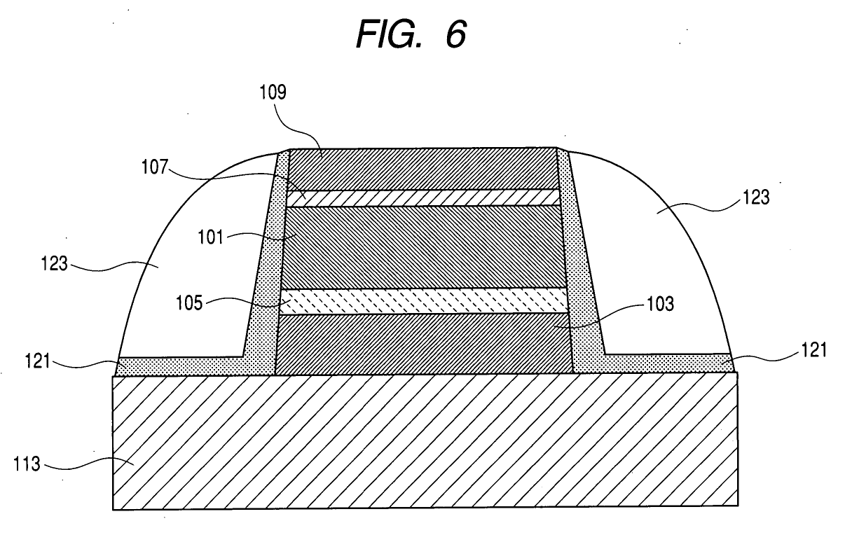

In the device according to the present invention, no side hard bias or side shield is required for the TMR, BMk, CCP-CPP or GMR heads. The structure having a side shield 123 is shown in FIG. 6. More specifically, an insulator 121 is provided on the sides of the spin valve. Then, a soft shield 123 is provided to protect the magnetoresistive element from neighboring tracks effect.

Further, in the case of the TMV BMR and CCP-CPP heads, a related art side hard bias that is made of hard magnet may be included in place of the side shield 123. However, this related art hard bias is not included for the GMR heads of the present invention. The side hard bias is made of hard magnet having a high coercivity (e.g. CoPt, CoPtCr alloy), which means that the magnetization direction of the side hard bias is fixed to stabilize the free layer in the mono-domain structure. While the side shield is made of a material having a low coercivity and a high permeability, NiFe or the like can be used.

Additionally, a method of tilting the stabilizer layer is also provided. Each of the pinned layer, in-stack bias, and free layer must be successively annealed. To accomplish the annealing, the pinned layer is annealed at a relatively high temperature and a high applied field magnitude to set the magnetization of the pinned layer in the pre-defined direction (perpendicular to the air bearing surface). Next, the stabilizing layer (i.e. in-stack bias) has its magnetization fixed by annealing at a temperature below that of a blocking temperature of a first AFM layer that is used to fix the magnetization of the pinned layer, but higher than a blocking temperature of a second AFM layer that is used to fix the magnetization of the stabilizing layer. Then, the free layer is annealed at a low magnetic field and a moderate temperature that is below the blocking temperature of both of the AFM layers that are used to fix the respective magnetizations of the pinned layer and the stabilizing layer.

It is noted that the AFM layers are not shown in the foregoing drawings with respect to the embodiment, but are well known to those skilled in the art, and may be substantially similar to those of the related art. Further, the annealing steps at the foregoing temperatures (more specifically, the temperature differential) and applied magnetic fields and directions result in a tilting of the stabilizing layer field. Accordingly, the tilted stabilizer spin valve is produced by the above-described tilting method.

The present embodiment has various advantages. For example, but not by way of limitation, the related art problem of asymmetry is substantially solved by the embodiments, and the related art problem of hysteresis is also substantially solved.

Additionally, the foregoing embodiments are generally directed to a magnetoresistive element for a magnetoresistive read head. This magnetoresistive read head can optionally be used in any of a number of devices. For example, but not by way of limitation, as discussed above, the read head can be included in a hard disk drive (HDD) magnetic recording device.

However, the present invention is not limited thereto, and other devices that use the magnetoresistive effect may also comprise the magnetoresistive element of the present invention. For example, but not by way of limitation, a magnetic field sensor or a memory may also employ the present invention. The magnetic field sensor may be used in a magnetic resonance imaging (NM) device that measures a cross-section of a target tissue, such as a cross section of human anatomy (e.g., head), but the application thereof is not limited thereto. Such applications are within the scope of the present invention.

The present invention is not limited to the specific above-described embodiments. It is contemplated that numerous modifications may be made to the embodiments without departing from the spirit and scope of the invention as defined in the following claims.

What is claimed is:

1. A magnetoresistive element comprising:
a free layer having a magnetization adjustable in response to an external magnetic field;
a pinned layer having a substantially fixed magnetization;
a spacer sandwiched between said pinned layer and said free layer; and
a continuous, non-disjoined stabilizer layer positioned on said free layer opposite said spacer, wherein said stabilizer layer has a tilted magnetization direction, and said magnetoresistive element does not include a side hard bias layer.

2. The magnetoresistive element of claim 1, wherein said stabilizer layer comprises a first component that substantially stabilizes the free layer in a mono-domain structure, and a second component that substantially compensates interlayer coupling between said pinned layer and said free layer.

3. The magnetoresistive element of claim 1, wherein an angle of said tilted magnetization direction is from about 15 to about 75 degrees from an origin state that is about 180 degrees from a magnetization direction of said free layer.

4. The magnetoresistive element of claim 1, wherein said stabilizer layer has a width larger than a width of said free layer.

5. The magnetoresistive element of claim 1, wherein the spacer comprises one of an insulative material and a conductive material.

6. The magnetoresistive element of claim 1, wherein the spacer comprises an insulator matrix having at least one conductive nano-contact between said free layer and said pinned layer.

7. The magnetoresistive element of claim 6, wherein said at least one conductive nano-contact is one of magnetic and non-magnetic.

8. The magnetoresistive element of claim 1, further comprising a side shield positioned on a side of said stabilizer layer, said spacer, said pinned layer and said free layer.

9. A magnetoresistive element comprising:
a free layer having a magnetization direction adjustable in response to an external magnetic field;
a pinned layer having a substantially fixed magnetization direction;
a spacer sandwiched between said pinned layer and said free layer; and
a continuous, non-disjoined stabilizer layer positioned on said free layer opposite said spacer, wherein said stabilizer layer has a tilted magnetization direction;
an insulator positioned on side surfaces of said stabilizer layer, said spacer, said pinned layer and said free layer; and
a side hard bias positioned at an outer surface of said insulator, wherein the spacer comprises an insulator matrix having at least one conductive nano-contact between said free layer and said pinned layer, and said at least one conductive nano-contact is one of magnetic and non-magnetic.

10. The magnetoresistive sensor of claim 9, wherein said at least one conductive nano-contact comprises at least one of Ni, Co and Fe.

11. The magnetoresistive sensor of claim 9, wherein said stabilizer layer having said tilted magnetization direction comprises a first component that substantially stabilizes the free layer in a mono-domain state, and a second component that substantially compensates the interlayer coupling between said free layer and said pinned layer.

12. The magnetoresistive sensor of claim 9, wherein an angle of said tilted magnetization direction is from about 15 degrees to about 75 degrees from an origin state, which is about 180 degrees from a magnetization direction of said free layer.

13. The magnetoresistive sensor of claim 9, wherein said stabilizer layer has a larger width than said free layer.

14. A magnetoresistive element comprising:
a free layer having a magnetization direction adjustable in response to an external magnetic field;
a pinned layer having a substantially fixed magnetization direction;
a spacer sandwiched between said pinned layer and said free layer, said spacer comprising an insulator; and
a continuous, non-disjoined stabilizer layer positioned on said free layer opposite said spacer, wherein said stabilizer layer has a tilted magnetization direction;
an insulator positioned on side surfaces of said stabilizer layer, said spacer, said pinned layer and said free layer; and
a side hard bias positioned at an outer surface of said insulator.

15. A device comprising:
a free layer having a magnetization adjustable in response to an external magnetic field;
a pinned layer having a substantially fixed magnetization;
a spacer sandwiched between said pinned layer and said free layer; and
a continuous, non-disjoined stabilizer layer positioned on said free layer opposite said spacer, wherein said stabilizer layer has a tilted magnetization direction, and said magnetoresistive element does not include a side hard bias layer.

16. The device of claim 15, wherein said device comprises one of a magnetic field sensor and a memory.
